(19) United States
(12) Patent Application Publication
(10) Pub. No.: US 2016/0048219 A1
(43) Pub. Date: Feb. 18, 2016

(54) KEYBOARD WITH NEW BUTTON WITH NEW SYMBOL OF LANGUAGE

(71) Applicant: Aleksandr Dmitrievich GARMACH, Ryazan (RU)

(72) Inventor: Aleksandr Dmitrievich GARMACH, Ryazan (RU)

(21) Appl. No.: 14/775,404

(22) PCT Filed: Mar. 20, 2013
(86) PCT No.: PCT/RU2013/000229

§ 371 Date: Sep. 11, 2015

(51) Int. Cl. G06F 3/02; G06F 3/023

(52) U.S. Cl. CPC G06F 3/0219; G06F 3/0236

(57) ABSTRACT

I, as a writer, for several years is necessary on the keyboard new punctuation mark—a symbol of negative emotions. Because we have a symbol of positive emotions—an exclamation mark, which now means only those emotions. But we don't have on the keyboard symbol of negative emotions. Much better, if an exclamation mark indicates only positive emotions, as for the negative emotions is a different sign. The area of the technicians includes all devices to enter symbols, letters, and punctuation marks. On all modem keyboards there is enough space for the location the new button with a new sign—symbol of negative emotions.

Innovation keyboard with new button with new symbol (new punctuation mark or new sign) of Russian Language (new sign of English Language, the German language, French language, Ukrainian language), namely the button with the symbol of negative emotions—the symbol like the
inverted exclamation mark, but at ¼ shorter
(the character size ¾ of the height of a normal line), which is done in order to use the innovations:
positive emotions in the literature indicate an exclamation mark,
and negative emotions in the literature indicate a symbol like the inverted exclamation mark, but at ¼ shorter than the exclamation mark.

The task to be solved by the invention consists in the fact, that since 2008 in the official publication of my poems in Russia I used this method of displaying emotions in writing.

In this case, due to the absence of the sign on the keyboard, there are a number of inconveniences, when typing text.

The implementation of the invention and technical result: the keyboard add a new button with this sign, which will give an opportunity to more quickly and more conveniently insert in the text of this new punctuation mark.

1. The formula of the invention
Innovation keyboard with new button with new symbol (new sign) of Russian Language (new sign of English Language, the German language, French language, Ukrainian language), namely the button with the symbol of negative emotions—the symbol like the
inverted exclamation mark, but at ¼ shorter (the character size ¾ of the height of a normal line), which is done in order to use the innovations:
positive emotions in the literature indicate an exclamation mark,
and negative emotions in the literature indicate a symbol like the inverted exclamation mark, but at ¼ shorter than the exclamation mark.
